(19) United States
(12) Patent Application Publication
(10) Pub. No.: US 2021/0339477 A1
(43) Pub. Date: Nov. 4, 2021

(54) TECHNIQUES FOR PRODUCING THERMAL SUPPORT STRUCTURES IN ADDITIVE FABRICATION AND RELATED SYSTEMS AND METHODS

(71) Applicant: Formlabs, Inc., Somerville, MA (US)

(72) Inventors: Christopher Auld, Boston, MA (US); Connor Evans, Medford, MA (US)

(73) Assignee: Formlabs, Inc., Somerville, MA (US)

(21) Appl. No.: 16/865,276

(22) Filed: May 1, 2020

(51) Int. Cl. B29C 64/393; B33Y 50/02; B29C 64/153; B29C 64/268; B33Y 10/00; B29C 64/40

(52) U.S. Cl. CPC B29C 64/393; B33Y 50/02; B29C 64/40; B29C 64/268; B33Y 10/00; B29C 64/153

(57) ABSTRACT

Techniques for designing and fabricating thermal support regions via additive fabrication are described. Defects produced as a result of temperature differentials within an additive fabrication device that forms parts by sintering particles of material may be mitigated or avoided by directing energy to regions around a part that is sufficient to heat the material and cause it to partially sinter, but not enough to fully sinter the material. The mechanical properties of such a thermal support region may resist the effects caused by temperature gradients. In addition, or alternatively, the heating of the thermal support region material may reduce heat lost by nearby sintered material. In either or both cases, the thermal support region acts as a kind of ‘volumetric armor’ that surrounds some or all of the part and protects the part from defects.

### BACKGROUND

Additive fabrication, e.g., 3-dimensional (3D) printing, provides techniques for fabricating objects, typically by causing portions of a building material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, selective laser sintering or combinations thereof. Many additive fabrication techniques build parts by forming successive layers, which are typically cross-sections of the desired object. Typically each layer is formed such that it adheres to either a previously formed layer or a substrate upon which the object is built.

In one approach to additive fabrication, known as selective laser sintering, or “SLS,” solid objects are created by successively forming thin layers by selectively fusing together powdered material. One illustrative description of selective laser sintering may be found in U.S. Pat. No. 4,863,538, incorporated herein in its entirety by reference.

### SUMMARY OF THE DISCLOSURE

According to some aspects, a computer-implemented method of generating one or more thermal supports for an object is provided, the object to be fabricated by an additive fabrication device through directed application of energy onto a powdered material, the method comprising generating, using at least one processor, a first thermal support region for the object, at least part of the first thermal support region being positioned adjacent to the object, and generating, using the at least one processor, instructions that, when executed by the additive fabrication device, cause the additive fabrication device to operate an energy source to fabricate the object by directing energy from the energy source to a powdered material to consolidate a first three-dimensional region according to the object, and direct energy from the energy source to the powdered material to heat, but not consolidate, a second three-dimensional region according to the first thermal support region.

According to some aspects, at least one computer readable medium is provided comprising processor-executable instructions that, when executed, cause at least one processor to perform a method of generating one or more thermal supports for an object, the one or more thermal supports and the object to be fabricated via an additive fabrication device, the method comprising generating, using the at least one processor, a first thermal support region for the object, at least part of the first thermal support region being positioned adjacent to the object, and generating, using the at least one processor, instructions that, when executed by the additive fabrication device, cause the additive fabrication device to operate an energy source to fabricate the object by directing energy from the energy source to a powdered material to consolidate a first three-dimensional region according to the object, and direct energy from the energy source to the powdered material to heat, but not consolidate, a second three-dimensional region according to the first thermal support region.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF THE DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 depicts an illustrative selective laser sintering device, according to some embodiments;

FIGS. 2A-2D illustrate stages during fabrication that produce a curling defect in a single layer due to temperature differentials, according to some embodiments;

FIGS. 3A-3D illustrates stages during fabrication that produce a curling defect in a stack of layers due to temperature differentials, according to some embodiments;

FIGS. 4A-4B depict a process of producing a thermal support region, according to some embodiments;

FIGS. 4C-4F depict stages of consolidation of particles of material, according to some embodiments;

FIG. 5A depicts a layer of a part being fabricated alongside a portion of a thermal support, according to some embodiments;

FIG. 5B depicts layers of two parts being fabricated adjacent to one another alongside a portion of a thermal support, according to some embodiments;

FIG. 6 illustrates an example of a thermal support that is both alongside and beneath a part, according to some embodiments;

FIG. 7 is a flowchart of a method of fabricating a part with one or more thermal supports, according to some embodiments;

FIG. 8 is a block diagram of a system suitable for practicing aspects of the invention, according to some embodiments; and

FIG. 9 illustrates an example of a computing system environment on which aspects of the invention may be implemented.

### DETAILED DESCRIPTION

Some additive fabrication techniques, such as Selective Laser Sintering (SLS), form objects by fusing fine material, such as one or more powders, together into larger solid masses. This process of fusing fine material together is referred to herein as “sintering” or “consolidation,” and typically occurs by directing sufficient energy (e.g., heat and/or light) to the material to cause consolidation. Some energy sources, such as lasers, allow for direct application of energy onto a small area or volume. Other energy sources, such as heat beds or heat lamps, direct energy into a comparatively broader area or volume of material. Since consolidation of source material typically occurs at or above a critical temperature, producing parts as intended requires effective management of temperature within the source material.

In some additive fabrication systems, the source material is preheated to a temperature that is sufficiently low as to require minimal additional energy exposure to trigger consolidation. For instance, some conventional systems utilize radiative heating elements configured to consistently and uniformly heat the source material to below, but close to, the critical temperature for consolidation. A laser beam or other energy source directed at the material may provide sufficient energy to cause consolidation, thereby allowing controlled consolidation of material at a small scale.

In these systems, consistency of the temperature of the unconsolidated material may be critical to the successful fabrication of parts using the selective sintering process, both over the full area to be exposed by the focused energy source and over an extended time period as additional exposures are completed. In particular, when consolidating the material, the system should preferably maintain the temperature of the material at or above its consolidation temperature for sufficient time for the consolidation process to complete. Additionally, the system should preferably maintain the temperature of the unconsolidated material at as close to a constant temperature as feasible so that the total amount of energy actually delivered to an area of unconsolidated material can be predicted for a given energy exposure amount.

The thermal management approaches described above can be difficult to implement in practice, however, and numerous problems can emerge as a result of inconsistent heating. For instance, overheating of material during fabrication may alter the properties of the material, leading to brittle and/or less malleable material. Overheating may also cause powdered material to clump or aggregate in unintended areas, which can prevent an even deposition of fresh material across the fabrication bed. Conversely, underheating of the material during fabrication may result in a failure of the material to uniformly consolidate and/or may result in inferior surface features of the fabricated part.

Dimensional changes in the consolidated material, also known as shrinkage, can also be significantly influenced by both the temperature of a particular portion of material prior to exposure to focused energy and to the temperature profile of that portion following the exposure. As an example, heating different regions of powder to different temperatures and/or allowing similarly heated regions to cool at different rates, may result in significantly different degrees of expansion and contraction due to the thermal energy and subsequent melting and consolidation. These differential expansions and contractions may cause numerous part defects, including curling, cracking, incomplete consolidation, and warping. Inconsistent temperature at layers near to the surface of the powder bed, or at the powder bed surface, may be particularly troublesome, causing newly formed layers to warp and curl up. In some circumstances, such temperature differentials may prevent the successful formation of additional layers and may result in part failure. Referred to herein as “thermal shock,” these effects may be most pronounced when relatively cool regions are in immediate proximity to relatively hot regions of the powder bed, thus forming an undesirable temperature gradient between the cooler and warmer regions.

Some thermal management challenges are a result of significant heat applied to portions of material via exposure to a focused energy source. While this heat can cause consolidation, it also heats adjacent areas which may introduce additional temperature non-uniformities. The application and nature of these non-uniform “hot spots” can depend greatly upon the geometry of the part to be fabricated, and thus the areas exposed and heated by the focused energy source. This introduction of additional heat may tend to set up temperature differentials, or gradients, between layers and areas which have been recently exposed as compared to those layers and/or areas which have not been recently exposed. As discussed above, one undesirable result to such a temperature differential may be so-called thermal shock; when a fresh layer of comparatively cooler material is deposited over a layer into which a large amount of heat was deposited, consolidation in the new layer may result in warping or curling material as a result of this temperature differential. In general, sintering processes are sensitive to temperature differentials, resulting in or believed to contribute to a diverse array of part defects and failure modes. Such differentials may be especially severe where the size of the area to be exposed by the focused energy changes significantly between layers—that is, when there is a large differential in the cross-sectional area being consolidated between adjacent and/or nearby layers.

Conventionally, an operator of a device might manually analyze a part for fabrication to identify regions likely to result in steep interlayer temperature gradients and, where feasible, to alter the orientation of the part with respect to the layer forming direction so as to minimize the rate at which cross sectional areas change between layers. While altering the orientation of the object may improve outcomes for a variety of shapes, however, there are some shapes that may not have such an optimal orientation.

The inventors have recognized and appreciated that defects produced as a result of temperature differentials as discussed above may be mitigated or avoided by directing energy to regions around a part that is sufficient to heat the material and cause it to partially sinter, but not enough to fully consolidate the material. The mechanical properties of such a region of material—referred to herein as a “thermal support region”—may resist the effects caused by temperature gradients as described further below. In addition, or alternatively, the heating of the thermal support region material may reduce heat lost by nearby consolidated material. In either case, the thermal support region may act as a kind of ‘volumetric armor’ that surrounds some or all of the part and protects the part from defects.

As used herein, a “thermal support” or a “thermal support region” refers at least to a region that is heated through directed application of energy but is not heated enough to fully consolidate all the material in the region. During fabrication, a typical layer of material may, for instance, include a portion of a thermal support region around the perimeter of a layer of a part. Energy may be directed to a two-dimensional region to consolidate material and thereby form the layer of the part, and in addition, a shell around the two-dimensional region may be heated but not consolidated. In general, thermal support regions may be arranged beneath and/or alongside the part such that thermal support regions for a given layer of the part are produced in one or more earlier layers of material, and/or are produced in the same layer.

According to some embodiments, thermal support regions may be arranged adjacent to a part. This may include thermal support regions that are immediately adjacent to the part—that is, adjacent to the part with no gap between the thermal support region and the part, as well as thermal support regions that are adjacent to the part with a small gap (e.g., less than 1 mm, less than 0.5 mm, less than 0.2 mm) between the thermal support region and the part.

According to some embodiments, thermal support regions may be arranged alongside a part—that is, if parts are formed from layers stacked in a vertical direction, the thermal support regions may be arranged adjacent to the part in the horizontal direction. The thickness of the thermal support in the horizontal direction may be on the order of 2 mm or less. According to some embodiments, thermal support regions may be arranged beneath a part—that is adjacent to the part in the vertical direction and produced in earlier layers in the fabrication process. The thickness of the thermal support in the vertical direction may be on the order of 2 mm or less, although in general the thickness of the thermal support in the horizontal and vertical directions are not necessarily the same. In some cases, thermal supports may not be generated above the uppermost layer of a part because doing so may provide little or no benefits with respect to mitigating defects.

According to some embodiments, small negative internal features may be excluded from a thermal support. Since the material within a thermal support region is heated, particles of the material may adhere or be partially consolidated with one another even though the material is not fully consolidated. As a result, small internal spaces within a part may become blocked if they contain such material. Consequently, the process that generates the thermal support region(s) may identify negative internal features based on position and size and exclude them from the thermal support region(s).

According to some embodiments, an additive fabrication device may consolidate material via directed application of energy onto a small surface area of the material. For example, a laser beam may be directed onto the surface of the material to heat the material and thereby cause consolidation. In some cases, at least some of the material may be heated to reduce the amount of energy needed to cause consolidation. In some embodiments, the additive fabrication device may produce thermal supports in the same manner, but with a reduced output energy from the energy source and/or by directing the energy source onto the material for a smaller amount of time compared with the consolidation process. For example, the energy deposited per unit area by the energy source to produce solid material through consolidation may be 5 to 100 times greater than the energy deposited per unit area by the energy source to produce thermal supports.

Following below are more detailed descriptions of various concepts related to, and embodiments of, techniques for producing thermal supports. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

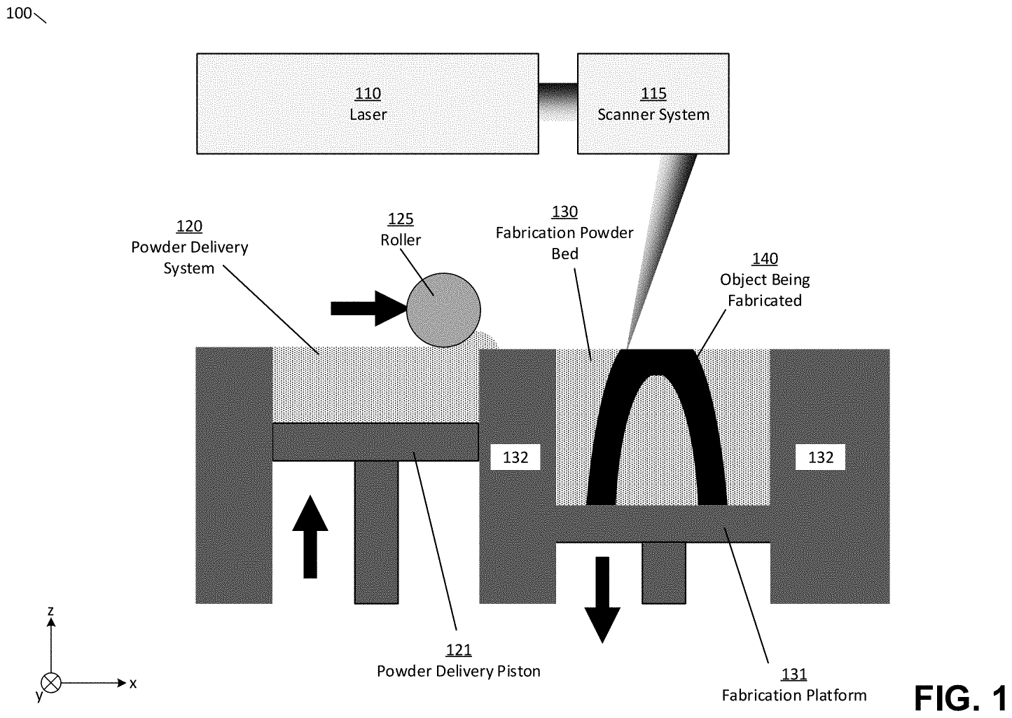

An illustrative system embodying certain aspects of the present application is depicted in FIG. 1. An illustrative selective laser sintering (SLS) additive fabrication device 100 comprises a laser 110 paired with a computer-controlled scanner system 115 disposed to operatively aim the laser 110 at the fabrication bed 130 and move over the area corresponding to a given cross-sectional area of a computer aided design (CAD) model representing a desired part. Suitable scanning systems may include one or more mechanical gantries, linear scanning devices using polygonal mirrors, and/or galvanometer-based scanning devices.

In the example of FIG. 1, the material in the fabrication bed 130 is selectively heated by the laser in a manner that causes the powder material particles to fuse (sometimes also referred to as “sintering” or “consolidating”) such that a new layer of the object 140 is formed. According to some embodiments, suitable powdered materials may include any of various forms of powdered nylon. Once a layer has been successfully formed, the fabrication platform 131 may be lowered a predetermined distance by a motion system (not pictured in FIG. 1). Once the fabrication platform 131 has been lowered, the material deposition mechanism 125 may be moved across a powder delivery system 120 and onto the fabrication bed 130, spreading a fresh layer of material across the fabrication bed 130 to be consolidated as described above. Mechanisms configured to apply a consistent layer of material onto the fabrication bed may include the use of wipers, rollers, blades, and/or other levelling mechanisms for moving material from a source of fresh material to a target location. Additional powder may be supplied from the powder delivery system 120 by moving the powder delivery piston 121 upwards.

Since material in the powder bed 130 is typically only consolidated in certain locations by the laser, some material will generally remain within the bed in an unconsolidated state. This unconsolidated material is commonly known in the art as the part cake. In some embodiments, the part cake may be used to physically support features such as overhangs and thin walls during the formation process, allowing for SLS systems to avoid the use of temporary mechanical support structures, such as may be used in other additive manufacturing techniques such as stereolithography. In addition, this may further allow parts with more complicated geometries, such as moveable joints or other isolated features, to be printed with interlocking but unconnected components.

The above-described process of producing a fresh layer of powder and consolidating material using the laser repeats to form an object layer-by-layer until the entire object has been fabricated. Once the object has been fully formed, the object and the part cake may be cooled at a controlled rate so as to limit issues that may arise with fast cooling, such as warping or other distortion due to variable rate cooling. The object and part cake may be cooled while within the selective laser sintering apparatus, or removed from the apparatus after fabrication to continue cooling. Once fully cooled, the object can be separated from the part cake by a variety of methods. The unused material in the part cake may optionally be recycled for use in subsequent prints.

In the example of FIG. 1, powder in the uppermost layer of the powder bed 130 is maintained at an elevated temperature, low enough to minimize thermal degradation, but high enough to require minimal additional energy exposure to trigger consolidation. Energy from the laser 110 is then applied to selected areas to cause consolidation. As discussed above, however, numerous problems can occur due to temperature differentials produced during this process. While some objects can be oriented so as to reduce or eliminate these issues, for most objects this is not feasible.

While the illustrative SLS device of FIG. 1 includes a laser as a source of directed energy, it will be appreciated that other SLS devices may rely on other sources of energy to cause consolidation of material. For instance, some SLS devices may utilize a two-dimensional array of independent energy sources, such as infra-red LEDs, and turn on selected ones of the LEDs to direct energy to selected regions of a powder bed. Other SLS devices may heat a portion of the powder bed while applying additional energy to selected regions of the powder bed and thereby cause consolidation. The subsequent discussion of thermal support techniques applies to any SLS device, including the example of FIG. 1 and alternatives mentioned here as the thermal support techniques do not depend on any particular method of delivering energy to a source material to cause consolidation of the material. This statement applies to methods of delivering energy to some or all the surface of the powder bed to heat but not consolidate the powder, in addition to methods of delivering energy to particular locations on the powder bed to consolidate powder at those locations.

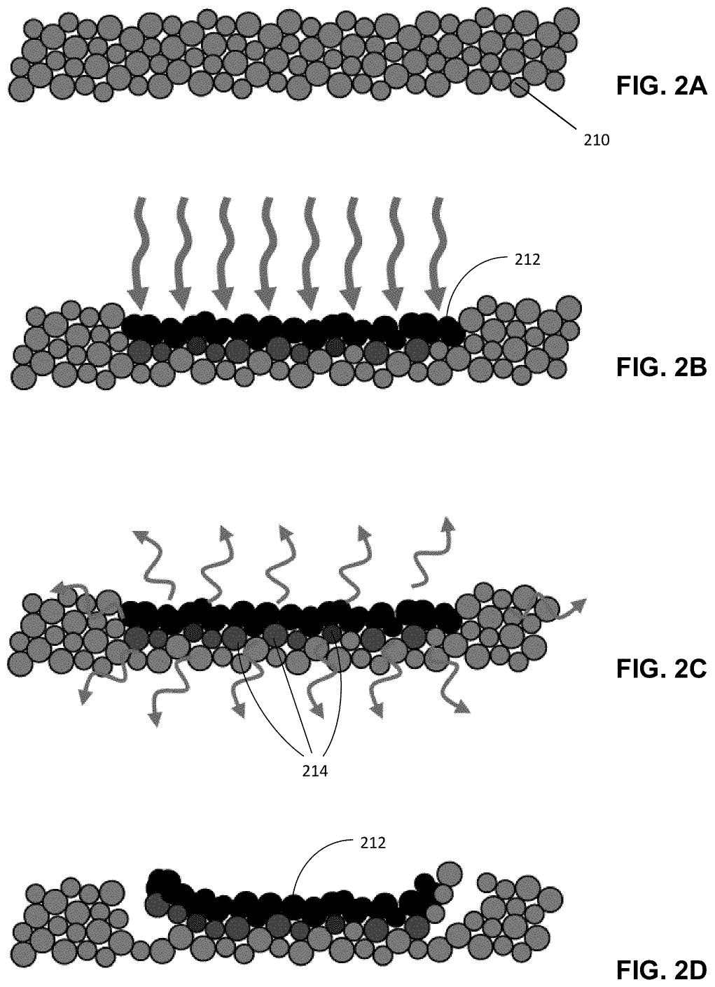

FIGS. 2A-2D illustrate stages during fabrication that produce a curling defect in a single layer due to temperature differentials, according to some embodiments. FIG. 2A depicts particles of a source material (e.g., a powder) 210. To consolidate some of these particles and form a layer of solid material during additive fabrication, energy may be directed onto the material as described above. As shown in FIG. 2B, some of the particles 212 are heated and consolidated in this process.

Subsequent to FIG. 2B, some of the heat deposited in the particles 212 is lost through conduction and/or convection to the surrounding environment because the nearby material and the ambient environment are both generally cooler than the heated particles 212. This heat transfer into some of the nearby material is depicted by FIG. 2C, and can result in some of that material melting and attaching to the particles 212 and/or in some partially melting and adhering to the particles 212. When the particles 212 then cool, and contract as a result of the cooling, instead of the contraction being in the plane of the layer of particles 212 the layer instead curls as shown in FIG. 2D. This curling is a result of the heat being lost to the nearby material, which caused at least some of that material to adhere or attach to the particles 212. As a result, when that nearby material cools with the particles 212, the combination curls as shown in the figure.

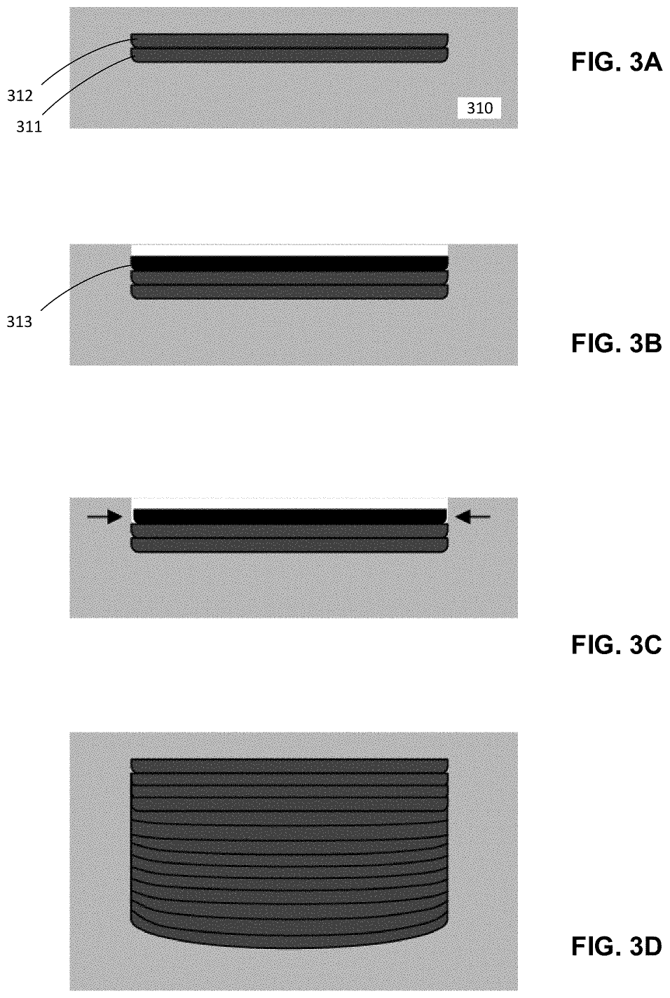

The curling phenomenon can also occur within a stack of layers, as depicted by FIGS. 3A-3D. FIG. 3A depicts layers of solid material 311 and 312, which have been formed through additive fabrication within source material 310. Subsequently, new layer 313 is formed on top of layer 312, as shown in FIG. 3B. As this layer cools within plane, as represented by the arrows shown in FIG. 3C, it applies a stress on the previously formed layers 311 and 312. While this stress may be comparatively small, it may build up over a number of layers to cause warping of a three-dimensional region of the part, as depicted by FIG. 3D.

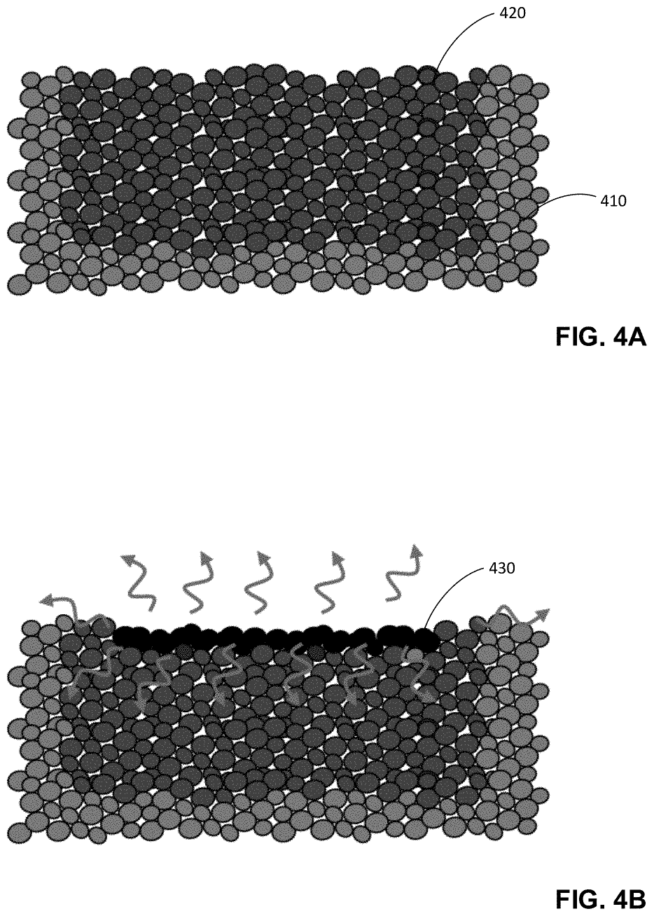

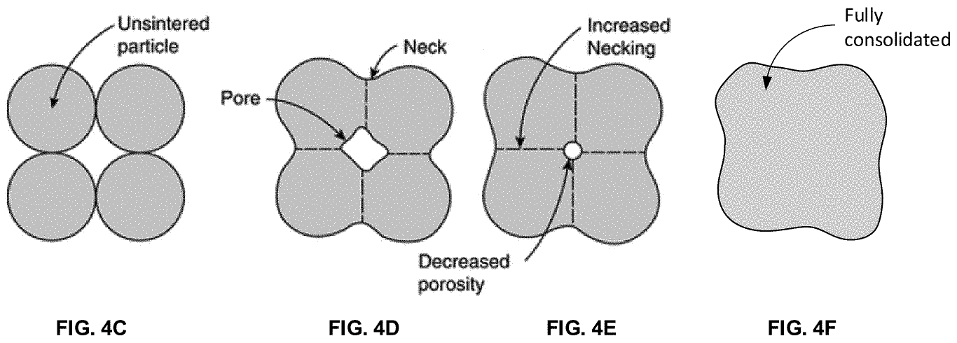

As discussed above, the inventors have recognized and appreciated that defects produced as a result of temperature differentials may be mitigated or avoided by directing energy to regions around a part that is sufficient to heat the material and cause it to partially sinter, but not enough to fully consolidate the material. FIGS. 4A-4B depict such a process of producing a thermal support region.

In the example of FIG. 4A, a region 420 of source material 410 has been heated an amount sufficient to partially sinter the material in the region, but not enough to fully consolidate the material to produce a solid layer. Subsequently, an uppermost layer 430 of the region 420 may be heated and consolidated. As described above in relation to FIGS. 2A-2D, the layer 430 may lose heat to the ambient environment and nearby material. However, instead of the layer curling as in FIG. 2D, layer 430 is protected against curling due to the previously produced thermal support region 420.

Without wishing to be bound by theory, it is understood that the thermal support region 420 may protect layer 430 against curling for either or both of the following reasons. First, because the layer 430 is formed adjacent to the thermal support region 420, which is a previously heated region of material, the layer 430 may not lose as much heat to the surrounding as was the case in the example of FIGS. 2A-2D. This reduced heat loss may lead to reduced curling. Second, because the layer 430 is formed adjacent to a partially sintered region, the mechanical force needed for the layer 430 to curl is greater than in the example of FIGS. 2A-2D. In a sense, the thermal support region 420 may act as an ‘anchor’ that resists the curling motion of layer 430.

To further illustrate the difference between partially sintered particles of a thermal support region and fully sintered particles of a layer of material, FIGS. 4C-4F depict a process of sintering particles according to some embodiments. In the example of FIG. 4C, four illustrative particles are depicted next to one another prior to sintering. Upon application of energy to the particles, they begin to melt and form connection points between them, as shown in FIG. 4D. These connection points may be referred to as “necks,” with the process of producing necks referred to as “necking.” As may be seen in FIG. 4D, when the particles neck, pores still remain between the particles. As heat continues to be applied, necking increases and the pore size gradually decreases, as shown in FIG. 4E. Eventually, the pores close and the particles are fully consolidated, as shown in FIG. 4F.

As referred to herein, material within a thermal support region has been heated sufficiently that it necks, but does not fully consolidate. In the context of FIGS. 4C-4F, this means that material within a thermal support region has the appearance of the material in FIG. 4D or FIG. 4E—the particles are necking and pores between the particles are still present. Powder containing particles that are necked but not fully consolidated may be distinguished from unconsolidated powder by, for instance, analyzing the size and shape of the powder particles with a microscope to determine if the particles are spherical and uniformly shaped (in the case of unconsolidated powder), or are clumped together and non-uniformly shaped (in the case of necked powder particles). Additionally, or alternatively, a powder sample may be melted using differential scanning calorimetry (DSC) or melt flow index (MFI) to determine the extent to which the power has necked.

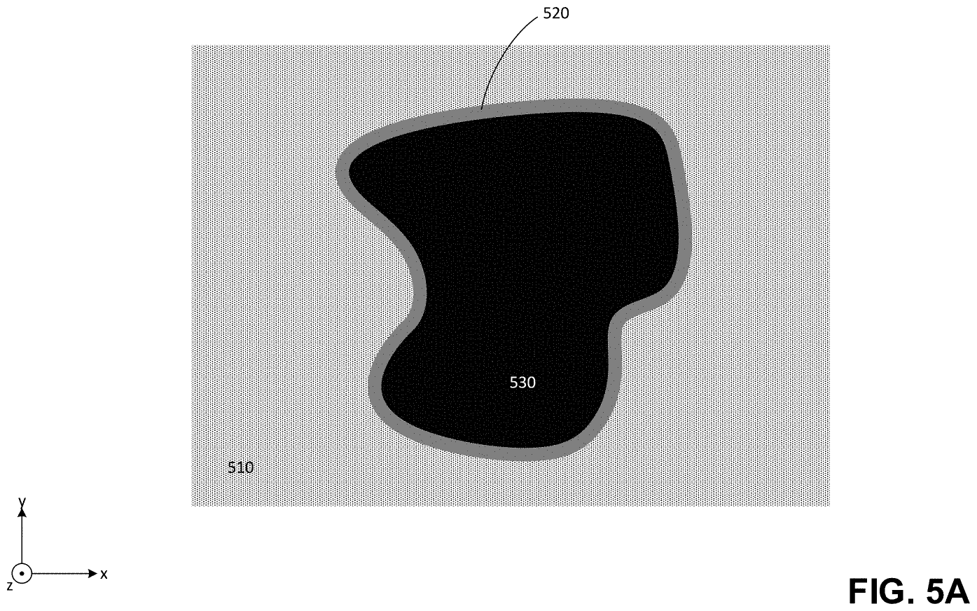

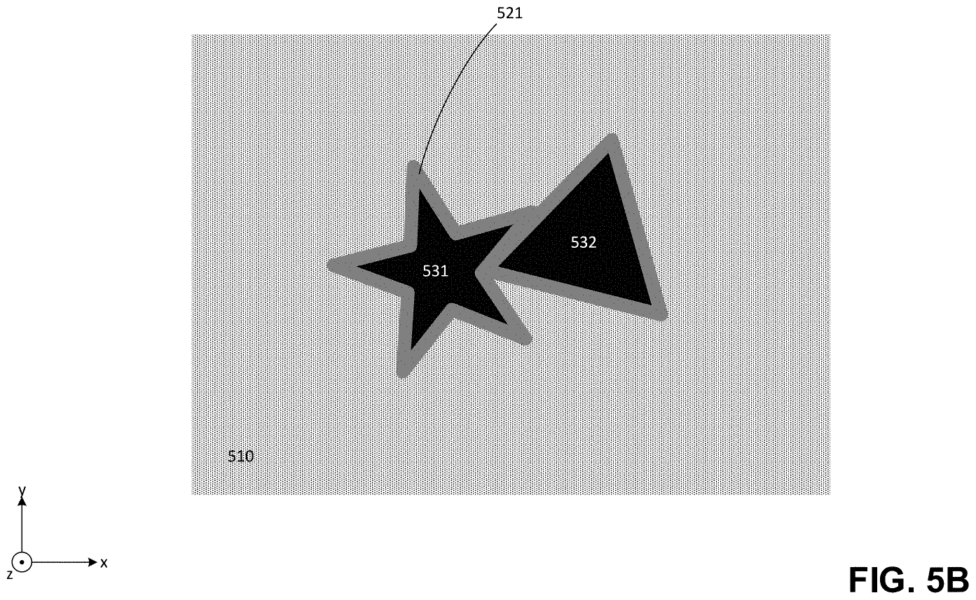

To further illustrate the characteristics of a thermal support, FIG. 5A depicts a layer of a part being fabricated alongside a portion of a thermal support, according to some embodiments. In the example of FIG. 5A, a view is shown of the x-y plane within an additive fabrication device, wherein the additive fabrication device forms parts from layers stacked in the z-direction. As such, the view of FIG. 5A shows a single ‘slice’ of the part. The region 530 represents consolidated material that is formed in accordance with a two-dimensional slice of an object. Thermal support region 520 is arranged around the perimeter of the region 530 to provide the aforementioned benefits of limiting defects due to thermal effects during fabrication.

In some embodiments, the thermal support region 520 may be produced prior to consolidation of the material 530. For instance, heat may be applied to the thermal support region 520 and to region 530 in an amount sufficient to cause necking of the material, then further heat may be applied to the region 530 to fully consolidate the material in that region. In some embodiments, the thermal support region 520 may be produced concurrently with region 530 by modulating the amount of energy directed onto region 520 compared with region 530. For instance, a laser beam may be directed along a path that passes over both regions 520 and 530 during fabrication of the layer of the part, wherein the laser power is reduced while the beam passes over region 520 and increased while the beam passes over region 530. In some embodiments, the thermal support region 520 may be produced concurrently with region 530 by directing the same amount of energy onto both regions 520 and 530, then applying additional energy onto region 530. In some embodiments, the thermal support region 520 may be produced subsequent to consolidation of the material 530. For instance, heat may be applied to the thermal support region 520 and to region 530 in an amount sufficient to cause necking of the material, then further heat may be applied to the region 530 to fully consolidate the material in that region. In some embodiments, the thermal support region 520 may be produced prior to production of region 530 by directing energy to the thermal support region 520, then directing comparatively more energy to region 530. In some embodiments, the thermal support region 520 may be produced subsequent to production of region 530 by directing energy to the region 530, then directing comparatively less energy to thermal support region 520.

In some embodiments, the width of the thermal support region 520, as measured in the x-y plane from the edge of the consolidated region 530 in a direction normal to the edge of the consolidated region 530 is greater than or equal to 100 μm, 150 μm, 200 μm, 300 μm, 500 μm, 750 μm, 1 mm, 1.2 mm, 1.5 mm, 2 mm, 5 mm, or 10 mm. In some embodiments, the width of the thermal support region 520 is less than or equal to 10 mm, 5 mm, 2 mm, 1.5 mm, 1.2 mm, 1 mm, 750 μm, 500 μm, 300 μm, 200 μm, 150 μm, or 100 μm. Any suitable combinations of the above-referenced ranges are also possible (e.g., a width of greater or equal to 150 μm and less than or equal to 1 mm, a width of greater or equal to 1 mm and less than or equal to 1.5 mm, a width of less than or equal to 2 mm and greater than or equal to 100 μm, etc.).

FIG. 5B depicts an example in which multiple parts are being fabricated within a single layer of powder and thermal supports are generated for both parts, according to some embodiments. In the example of FIG. 5B, two parts 531 and 532 are being fabricated but due to their proximity to one another, a single thermal support region 521 is generated. If the parts 531 and 532 were further way from one another within the x-y plane, each part may be surrounded by separate thermal support regions. However, in the example shown, a single contiguous thermal support region is generated for the depicted layer. The above discussion of sequences of operation in producing a thermal support region as well as region(s) of a part, and the discussion of the sizes of the thermal support regions, also applies to the example of FIG. 5B as well as any other thermal support region(s) that may be produced for a given part or set of parts.

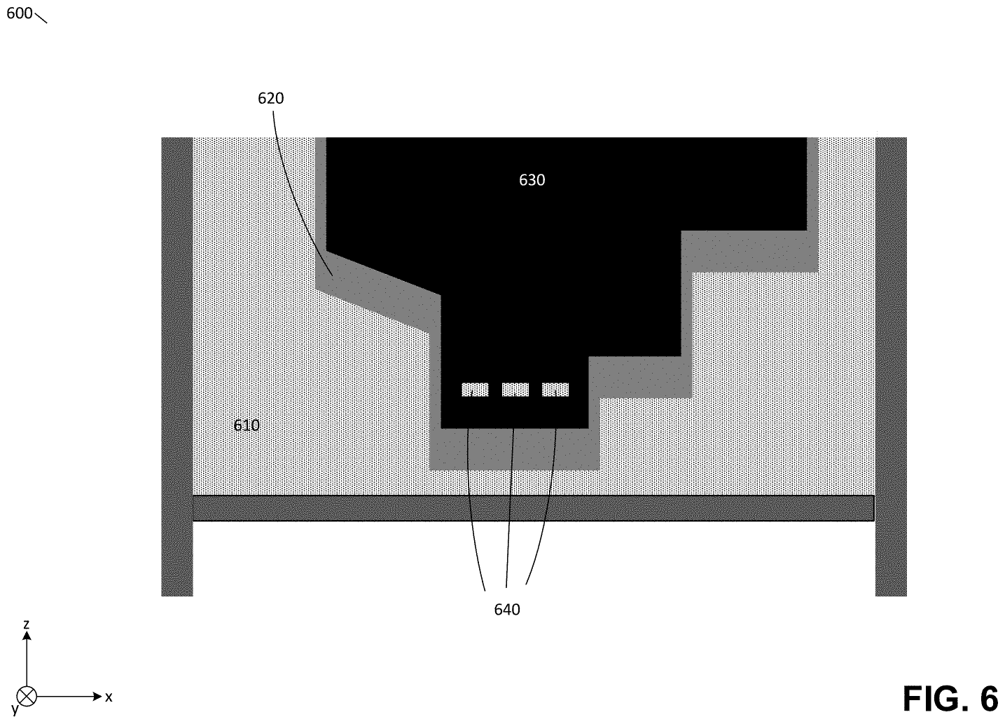

While the examples of FIG. 5A-5B depict a thermal support being arranged alongside the part in the x-y plane, a thermal support may additionally or alternatively be arranged beneath a part. FIG. 6 illustrates an example of a thermal support that is both alongside and beneath a part, according to some embodiments.

As shown in FIG. 6, a part 630 has been formed from a number of layers of material 610. A thermal support 620 has been produced surrounding at least some of the part 630. The state of part 630 shown in FIG. 6 may represent a partially fabricated state or a fully fabricated state, as thermal supports may not be necessary to produce in layers above the top of a part. As discussed above, the defects that arise in the absence of thermal supports may be due to temperature differentials between the part and the powder when portions of the part are consolidated. As a result, it may not be necessary to produce any thermal supports on the upper surfaces of a part. Thermal supports may therefore, in at least some cases, surround the sides and bottom of a part, but not the top of the part. As such, thermal supports may not be formed for a given part in any layers of powder that are deposited after the final layer of consolidated material is produced for the part. Where multiple parts are being fabricated in a single printing process, thermal support for one part may be formed in layers above the top of another part, however.

In the example of FIG. 6, the size of the thermal support in the vertical (z) direction is different to the size of the thermal support in the horizontal (x) direction. While these sizes may be the same in some cases, there may be a benefit in producing the thermal support to have a thickness in the vertical direction that is greater than in the horizontal direction.

In some embodiments, the height of the thermal support region 620, as measured in the z-direction is greater than or equal to 100 μm, 150 μm, 200 μm, 300 μm, 500 μm, 750 μm, 1 mm, 1.2 mm, 1.5 mm, 2 mm, 5 mm or 10 mm. In some embodiments, the height of the thermal support region 620 is less than or equal to 10 mm, 5 mm, 2 mm, 1.5 mm, 1.2 mm, 1 mm, 750 μm, 500 μm, 300 μm, 200 μm, 150 μm, or 100 μm. Any suitable combinations of the above-referenced ranges are also possible (e.g., a height of greater or equal to 150 μm and less than or equal to 1 mm, a height of greater or equal to 1 mm and less than or equal to 1.5 mm, a height of less than or equal to 2 mm and greater than or equal to 100 μm, etc.).

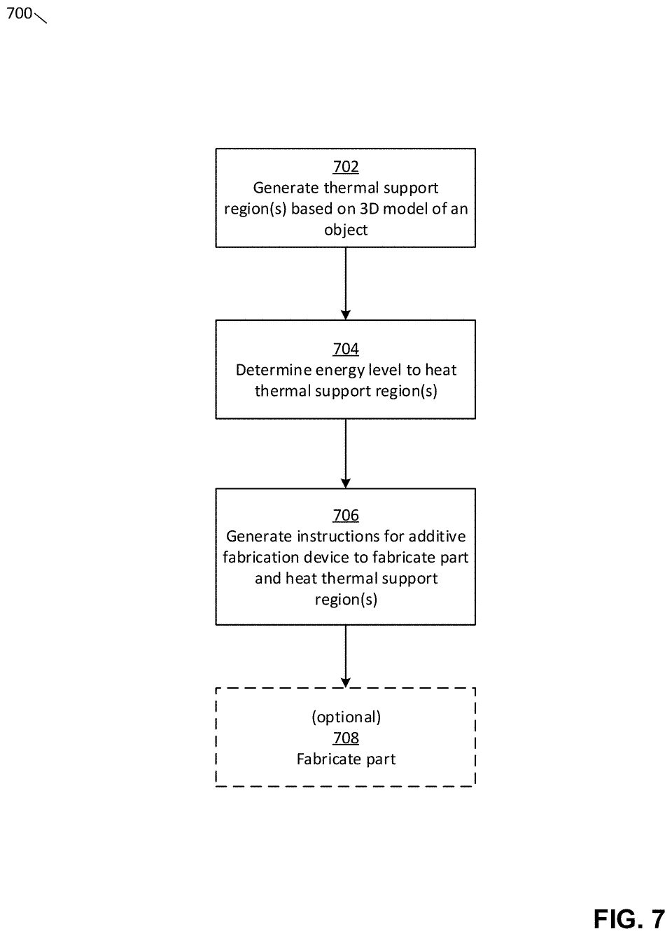

FIG. 7 is a flowchart of a method of fabricating a part with one or more thermal supports, according to some embodiments. At least part of method 700 may be performed by a suitable computing device, examples of which are discussed below. For instance, act 702, 704 and 706 may be performed by a suitable computing device, and optional act 708 may be performed by an additive fabrication device.

In act 702, the size and shape of one or more thermal support regions are generated based on a 3D model of an object. Act 702 may comprise one or more automated manipulations of the 3D model of the object to produce a 3D model of the thermal support region(s). For instance, act 702 may comprise an operation to produce an shape with a surface offset from the surface of the 3D model of the object, an operation to hollow out the shape offset from the 3D model of the object, etc.

In some embodiments, act 702 may comprise the following operations for each layer of the build volume. First, cross-sections of each object present within a layer of the build volume are identified and negative cross-sectional features below a threshold size excluded from subsequent consideration for thermal support regions. Thermal support regions may be determined for any remaining cross-sections by generating regions extending out from the perimeter of the cross-sections by a desired distance corresponding to the thickness of the thermal supports.

According to some embodiments, the height and the width of the thermal support region(s) may be different. For instance, the thermal support regions may have a height (thickness in the build direction) that is greater than the width (thickness perpendicular to the build direction). Suitable values for the height and width of a thermal support region are discussed above. Act 702 may comprise one or more 3D modeling operation that are performed based on the selected values of the height and width. For example, a surface offset operation may be performed based on the height and/or width.

According to some embodiments, act 702 may comprise excluding internal regions from a model generated for a thermal support. As discussed above, forming a thermal support within a small internal spaces in a part may cause the space to be blocked because the thermal support material does not flow as a powder, despite not being fully consolidated. As a result, act 702 may comprise performing one or more operations to remove three-dimensional portions of the thermal support corresponding to such internal spaces. For instance, in some embodiments, one or more internal spaces may be identified by analyzing the 3D model of the object to be fabricated based on certain criteria such as boundedness, size, orientation, etc. The identified internal spaces may be subtracted from the generated thermal support model by, for instance, performing one or more Boolean operations between a model of an internal space and the thermal support model.

In some embodiments, act 702 may comprise excluding small negative spaces that are partially but not fully bounded may be excluded based on their size and the extent to which they are bounded by positive regions. For instance, spaces between the teeth of a gear shape may be excluded if the spaces are small enough, because thermal support regions produced in those spaces may inhibit the gear from moving once fabricated. In some embodiments such as those depicted in FIG. 5B, where two or more objects share a combined thermal support region, thermal supports may be excluded from certain small spaces between two or more objects.

In act 704, a suitable energy level is determined to apply to material during fabrication to form the thermal support(s) generated in act 702. During subsequent fabrication of the part and thermal support(s), a suitable source of directed energy may be operated to apply energy at the determined level to form the thermal support(s). Determination of the energy level may be based on a number of parameters of the fabrication process to be performed, including but not limited to, properties of the source material to be used during fabrication (e.g., how reflective/absorptive the material is), a temperature to which the source material will be heated prior to application of directed energy to the material (to form the thermal support), or combinations thereof.

According to some embodiments, a ratio between: i) the energy level determined in act 704 to be applied by a source of directed energy to form a thermal support; and ii) the energy level to be applied by the source of directed energy to consolidate material may be greater than or equal to 0.01, 0.02, 0.05, 0.08, 0.1, 0.15, 0.2, 0.3, or 0.5. According to some embodiments, the ratio may be less than or equal to 0.5, 0.3, 0.25, 0.2, 0.15, 0.1, 0.08, 0.05, or 0.02. Any suitable combinations of the above-referenced ranges are also possible (e.g., a ratio of greater or equal to 0.02 and less than or equal to 0.1).

In act 706, instructions are generated for an additive fabrication device to fabricate the part by consolidating the material and to form the thermal support(s) by heating, but not consolidating, the material. The instructions may be generated based on the energy level determined in act 704, the 3D model of the object, and on the 3D model of the thermal support(s) generated in act 702. In some embodiments, the 3D model of the object and the 3D model of the thermal support(s) may be sliced together or separately to determine the shape of each two-dimensional region of the part and thermal support to be formed in each layer during fabrication.

Method 700 may optionally include act 708 in which the instructions generated in act 706 are executed by an additive fabrication device to fabricate the part and form the thermal support(s).

According to some embodiments, an alternative approach to producing a thermal support comprises depositing a substance onto powder in a layer that is neither a region of a part or a thermal support region, where the substance inhibits absorption of energy by the material onto which it is deposited. As a result, a heater then applies heat all over the material bed would therefore preferentially apply heat to parts and thermal supports. This heat may be sufficient to create the thermal support as described above. Subsequently, energy can be directed to the regions of the part to fully consolidate that material.

According to some embodiments, an alternative approach to producing a thermal support comprises depositing a substance onto powder in a layer that either a region of a part or a thermal support region, where the substance increases absorption of energy by the material onto which it is deposited. In the case of depositing the substance onto a thermal support region, heating of all of the powder may be sufficient to produce necking of the material in the thermal support region only because of its increased absorption. In the alternative case of depositing the substance onto a region of a part, the same energy may be applied to the thermal support region and the region of the part, thereby causing necking in the thermal support region but causing full consolidation in the region of the part because of its increase absorption.

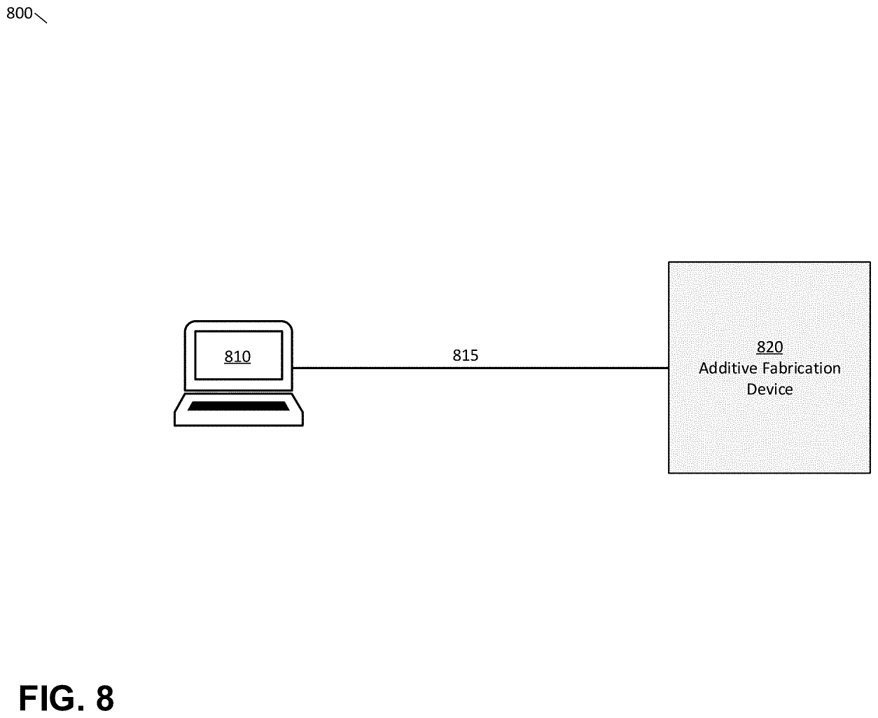

FIG. 8 is a block diagram of a system suitable for practicing aspects of the invention, according to some embodiments. As described above, thermal supports are three-dimensional structures that may be generated to aid in thermal management during fabrication of parts from fine materials, such as powders. System 800 illustrates a system suitable for said generation of thermal supports and subsequent operation of an additive fabrication device to fabricate an object with thermal supports. According to some embodiments, computer system 810 may execute software that generates one or more thermal supports for an object. Such generation may comprise generation of three-dimensional thermal supports based on a three-dimensional model of the object, followed by the determination of a plurality of two-dimensional layers of the combined object-support model (sometimes referred to as “slicing”). Alternatively, a three-dimensional model of the object may be sliced and additional two-dimensional regions representing the thermal support structure may be added to the two-dimensional slices of the object. Irrespective of which approach is employed, the net result is to produce data describing two-dimensional layers that may each comprise sections of the object and/or the thermal support(s). Instructions may then be generated from this layer data to be provided to an additive fabrication device, such as additive fabrication device 820, that, when executed by the device, fabricates the layers and thereby fabricates the object and the thermal support(s). Such instructions may be communicated via link 815, which may comprise any suitable wired and/or wireless communications connection. In some embodiments, a single housing holds the computing device 810 and additive fabrication device 820 such that the link 815 is an internal link connecting two modules within the housing of system 800.

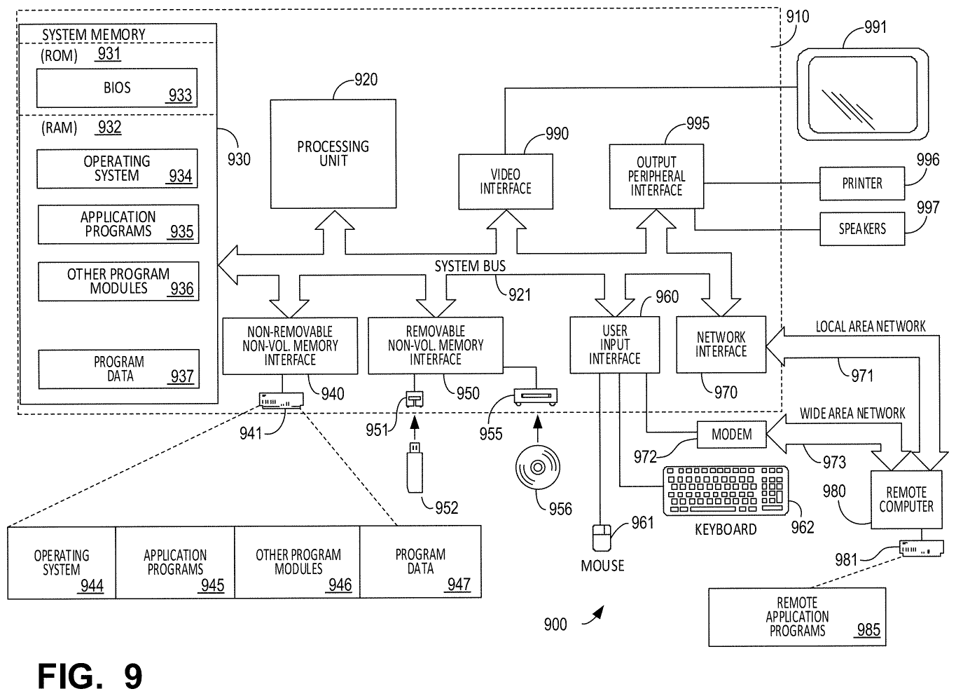

FIG. 9 illustrates an example of a suitable computing system environment 900 on which the technology described herein may be implemented. For example, computing environment 900 may form some or all of the computer system 810 shown in FIG. 8. The computing system environment 900 is only one example of a suitable computing environment and is not intended to suggest any limitation as to the scope of use or functionality of the technology described herein. Neither should the computing environment 900 be interpreted as having any dependency or requirement relating to any one or combination of components illustrated in the exemplary operating environment 900.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 9, an exemplary system for implementing the technology described herein includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a flash drive 951 that reads from or writes to a removable, nonvolatile memory 952 such as flash memory, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a non-transitory computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software,” when used herein, are used in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer-implemented method of generating one or more thermal supports for an object, the object to be fabricated by an additive fabrication device through directed application of energy onto a powdered material, the method comprising:
generating, using at least one processor, a first thermal support region for the object, at least part of the first thermal support region being positioned adjacent to the object; and
generating, using the at least one processor, instructions that, when executed by the additive fabrication device, cause the additive fabrication device to operate an energy source to:
fabricate the object by directing energy from the energy source to a powdered material to consolidate a first three-dimensional region according to the object; and
direct energy from the energy source to the powdered material to heat, but not consolidate, a second three-dimensional region according to the first thermal support region.

2. The method of claim 1, wherein the at least part of the first thermal support region is positioned immediately adjacent to the object.

3. The method of claim 1, wherein the at least part of the first thermal support region is positioned adjacent to the object with a gap of less than 1 mm between the at least part of the first thermal support region and the object.

4. The method of claim 1, wherein the instructions, when executed by the additive fabrication device:
operate the energy source at a first energy level while directing energy to the powdered material to heat, but not consolidate, the second three-dimensional region;
operate the energy source at a second energy level while directing energy to consolidate the first three-dimensional region, and
wherein the second energy level is between 5 and 100 times greater than the first energy level.

5. The method of claim 4, wherein the second energy level is between 10 and 50 times greater than the first energy level.

6. The method of claim 4, further comprising determining the first energy level and second energy level based on one or more material properties of the powdered material.

7. The method of claim 4, further comprising determining the first energy level and second energy level based on a bed temperature of the powdered material to which the additive fabrication device heats the powdered material.

8. The method of claim 1, further comprising executing the instructions by the additive fabrication device, thereby fabricating the object and heating the first thermal support region.

9. The method of claim 1, further comprising identifying at least one portion of the first thermal support region arranged within the object and, in response to identifying the at least one portion of the thermal support region, excluding the at least one portion from the first thermal support structure.

10. The method of claim 1, wherein a width of the first thermal support region is between 0.1 mm and 1.5 mm.

11. The method of claim 1, wherein generating the first thermal support region for the object comprises generating, based on a three-dimensional model of the object, a shell around at least part of the three-dimensional model.

12. The method of claim 11, wherein the shell has a first thickness in width and length directions and a second thickness, greater than the first thickness, in a height direction.

13. At least one computer readable medium comprising processor-executable instructions that, when executed, cause at least one processor to perform a method of generating one or more thermal supports for an object, the one or more thermal supports and the object to be fabricated via an additive fabrication device, the method comprising:
generating, using the at least one processor, a first thermal support region for the object, at least part of the first thermal support region being positioned adjacent to the object; and
generating, using the at least one processor, instructions that, when executed by the additive fabrication device, cause the additive fabrication device to operate an energy source to:
fabricate the object by directing energy from the energy source to a powdered material to consolidate a first three-dimensional region according to the object; and
direct energy from the energy source to the powdered material to heat, but not consolidate, a second three-dimensional region according to the first thermal support region.

14. The at least one computer readable medium of claim 13, wherein the at least part of the first thermal support region is positioned immediately adjacent to the object.

15. The at least one computer readable medium of claim 13, wherein the at least part of the first thermal support region is positioned adjacent to the object with a gap of less than 1 mm between the at least part of the first thermal support region and the object.

16. The at least one computer readable medium of claim 13, wherein the instructions, when executed by the additive fabrication device:
operate an energy source at a first energy level while directing energy to the powdered material to heat, but not consolidate, the second three-dimensional region;
operate the energy source at a second energy level while directing energy to consolidate the first three-dimensional region, and
wherein the second energy level is between 5 and 100 times greater than the first energy level.

17. The at least one computer readable medium of claim 16, wherein the second energy level is between 10 and 50 times greater than the first energy level.

18. The at least one computer readable medium of claim 16, further comprising determining the first energy level and second energy level based on one or more material properties of the powdered material.

19. The at least one computer readable medium of claim 16, further comprising determining the first energy level and second energy level based on a bed temperature of the powdered material to which the additive fabrication device heats the powdered material.

20. The at least one computer readable medium of claim 13, further comprising executing the instructions by the additive fabrication device, thereby fabricating the object and heating the first thermal support region.

21. The at least one computer readable medium of claim 13, further comprising identifying at least one portion of the first thermal support region arranged within the object and, in response to identifying the at least one portion of the thermal support region, excluding the at least one portion from the first thermal support structure.

22. The at least one computer readable medium of claim 13, wherein a width of the first thermal support region is between 0.1 mm and 1.5 mm.

23. The at least one computer readable medium of claim 13, wherein generating the first thermal support region for the object comprises generating, based on a three-dimensional model of the object, a shell around at least part of the three-dimensional model.

24. The at least one computer readable medium of claim 23, wherein the shell has a first thickness in width and length directions and a second thickness, greater than the first thickness, in a height direction.
